(19) United States
(12) Patent Application Publication
(10) Pub. No.: US 2017/0080379 A1
(43) Pub. Date: Mar. 23, 2017

(54) METHOD AND SYSTEM FOR ENHANCING THE MASS TRANSFER OF A SOLUBLE GAS

(71) Applicant: Ohio University, Athens, OH (US)

(72) Inventors: Alex Anthony Lunka, Chardon, OH (US); David James Bayless, Athens, OH (US)

(21) Appl. No.: 15/126,594

(22) PCT Filed: Feb. 12, 2015
(86) PCT No.: PCT/US15/15596

§ 371 Date: Sep. 16, 2016

Related U.S. Application Data
(60) Provisional application No. 61/972,589, filed on Mar. 31, 2014.

(51) Int. Cl. B01D 53/18; B01D 53/14

(52) U.S. Cl. CPC B01D 53/18; B01D 53/1475; B01D 2252/103

(57) ABSTRACT

A method for enhancing the mass transfer rate of a soluble gas from a gaseous phase to an aqueous phase is provided. The method comprises positioning a membrane formed from fibers relative to a supply of liquid such that a portion of the membrane is submerged in the supply of liquid and is thereby wetted. The method further comprises moving the wetted portion of the membrane relative to the supply of liquid such that the wetted portion of the membrane exits from the supply of liquid to expose the liquid in the wetted portion of the membrane to a soluble gas. The method further comprises submerging the wetted portion in the supply of liquid.

### PRIORITY CLAIM

This application claims the benefit of the filing date of Mar. 31, 2014 of U.S. Provisional Patent Application Ser. No. 61/972,589, which is incorporated herein by reference.

### FIELD OF THE INVENTION

This invention generally relates to the field of gas to liquid mass transfer of soluble gas.

### BACKGROUND

Gas-to-liquid mass transfer has numerous industrial applications. Soluble gases, such as carbon dioxide and ammonia, can be captured and absorbed into a solvent such as water. One particular application where gas-to-liquid mass transfer has potential for significant growth is in the use of natural sinks for sequestering carbon dioxide or other gases from air. Other applications of gas to liquid mass transfer include the production of microalgae as a feedstock for the mitigation of carbon dioxide emission, and the production of biofuels. Such applications require a consistent and controlled supply of inorganic carbon to the microalgae (or cyanobacteria) culture. The carbon dioxide must be introduced into the growth medium (i.e., water) of the microalgae in a way that does not abruptly and significantly reduce the pH of the growth medium, which may happen as carbonic acid forms when carbon dioxide is absorbed by, and reacts with water.

Previous versions of the technology for gas to liquid mass transfer utilize a stationary membrane mounted in tension below a conduit system which receives fluid via a pump. The pump delivers a liquid to the conduit system, which selectively delivers the liquid to the stationary membrane to create a falling film onto the membrane. The falling film eventually reaches the bottom of the membrane whereby the liquid drips into a pool of liquid. Existing systems are complex and require a relatively high power input in order to operate. For example, these systems require pumps, the use of which may be costly due to the required power input, as well as the cost of acquiring such pumps, which often must be custom made. In addition to the cost, pumps add to the complexity and may lead to maintenance costs due to the possibility of the pumps and/or the conduit system becoming clogged. Furthermore, current systems may require a tensioning system to maintain the membrane in a taut state to enhance or provide for capillary action flow of the liquid through the membrane. Tensioning systems add to the cost and complexity of the designs. Because of these and other reasons, using the existing systems on a large scale is less technically and economically feasible. There is therefore a need to address these and other issues in the art.

### SUMMARY

In that regard, a method for enhancing the mass transfer rate of a soluble gas from a gaseous phase to an aqueous phase is provided. The method comprises positioning a membrane formed from fibers relative to a supply of liquid such that a portion of the membrane is submerged in the supply of liquid and is thereby wetted. The method further comprises moving the wetted portion of the membrane relative to the supply of liquid such that the wetted portion of the membrane exits from the supply of liquid to expose the liquid in the wetted portion of the membrane to a soluble gas. The method further comprises submerging the wetted portion in the supply of liquid.

A system for enhancing the mass transfer rate of a soluble gas from a gaseous phase to an aqueous phase is also provided. The system comprises a reservoir for holding a supply of liquid. The system further comprises a membrane comprised of a plurality of fibers and positioned relative to the reservoir such that at least a portion of the membrane may be submerged in the supply of liquid and thereby wetted. The system further comprises a drive system configured to engage the membrane and move the wetted portion of the membrane into and out of the supply of liquid.

A method for transferring a soluble gas from a gaseous phase to an aqueous phase is also provided. The method comprises positioning a membrane formed from fibers relative to a supply of liquid such that a portion of the membrane is submerged in the supply of liquid. The method further comprises moving the membrane relative to the supply of liquid such that the submerged portion of the membrane exits from the supply of liquid, thereby forming a film of the liquid on the membrane, wherein soluble gas dissolves into the film. The method further comprises submerging the portion of the membrane including the film in the supply of liquid after the film becomes saturated with the dissolved soluble gas.

### BRIEF DESCRIPTION OF THE DRAWINGS

FIG. 1 is a front view of a system for enhancing the mass transfer rate of at least one soluble gas from a gaseous phase to an aqueous phase, including a membrane and a supply of liquid.

FIG. 2A is a side view of the system of FIG. 1.

FIG. 2B is a detailed side view of the system of FIG. 1.

FIG. 2C is a view similar to FIG. 2B, showing a film of liquid on the membrane after the membrane has moved relative to the supply of liquid.

FIG. 3 is a detailed side view of an alternative embodiment of a membrane.

FIGS. 4 and 5 show data relating to the energy use of a motor of a drive system associated with the system of FIG. 1, at different speeds of the motor.

FIGS. 6 through 9 show data relating to the pH and/or total inorganic carbon concentration over time in the supply of liquid.

### DETAILED DESCRIPTION

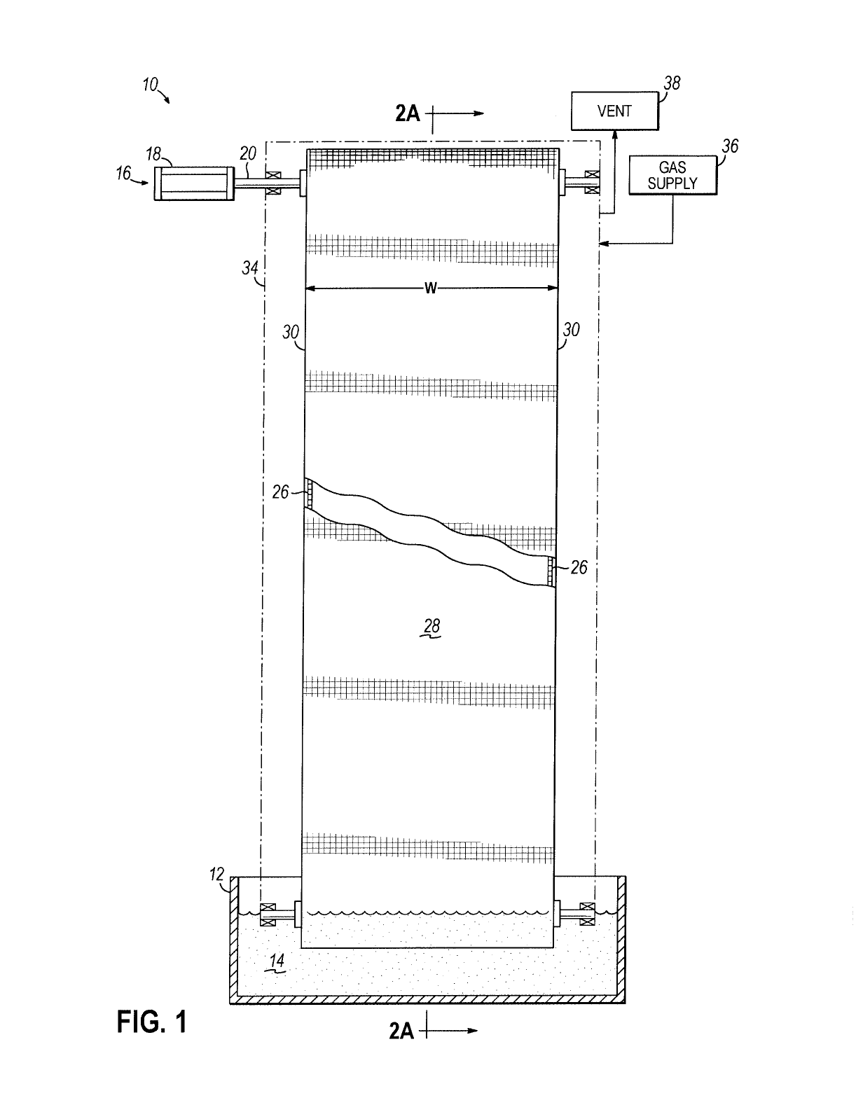

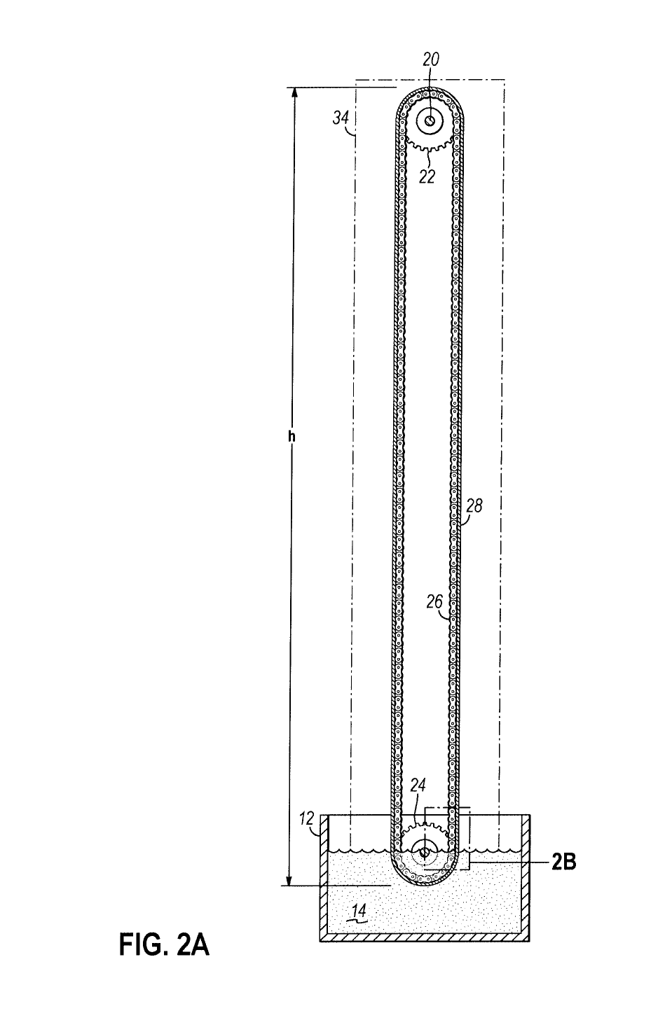

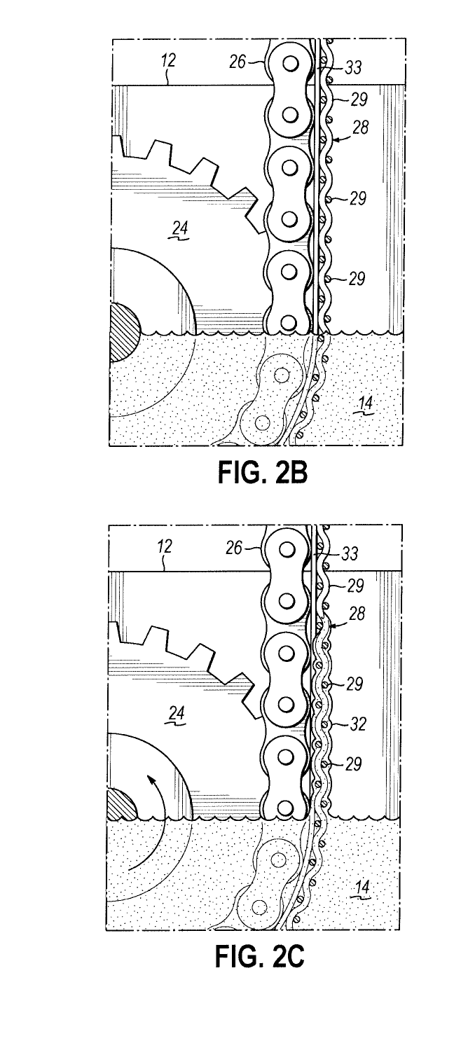

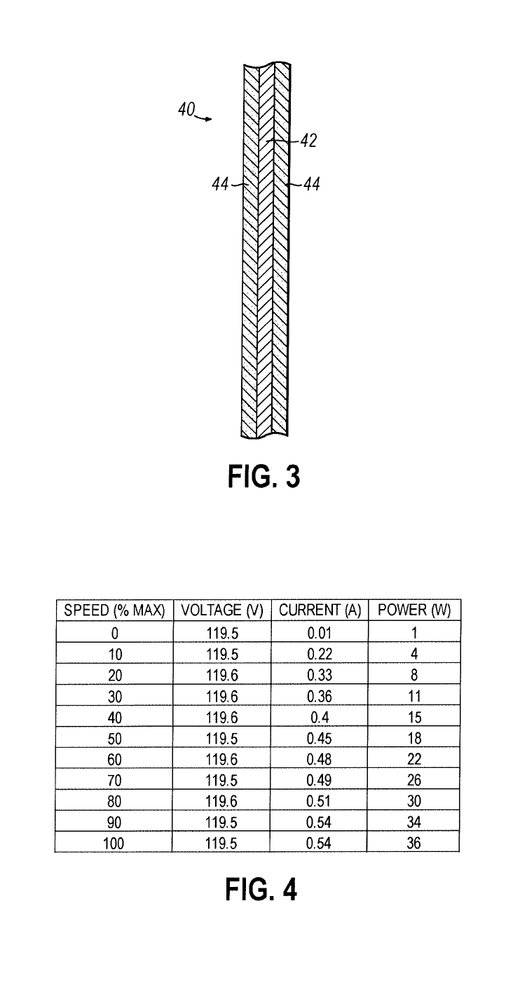

FIGS. 1 through 2B show a system 10 for enhancing the mass transfer rate of at least one soluble gas from a gaseous phase to an aqueous phase. The system 10 includes a reservoir 12 including a supply of liquid 14. In one embodiment, the liquid 14 is water. However, in other embodiments, the liquid 14 may be different depending on the particular gas that is desired to be dissolved into the liquid 14, as described in more detail below. Moreover, in other systems, the supply of liquid 14 may be much larger, and may be man-made or natural. For example, the supply of liquid 14 may be a raceway, or a body of water such as a pond or lake. The system 10 also includes a drive system 16 having a motor 18 which drives a drive shaft 20, which in turn drives a pair of upper, driven sprockets 22 operably coupled to the drive shaft 20. The system 10 also includes a set of lower, idler sprockets 24. Each of the chains 26 operably couples a driven sprocket 22 to a respective idler sprocket 24. In the embodiment shown, the chains 26 and sprockets 22, 24 are made from stainless steel. If a lubricant is utilized for the drive system 16, the lubricant used should not inhibit the drawing up of water 14 by the membrane 28. In an alternative embodiment, the drive system 16 may be a belt system including belts and pulleys (not shown), for example, rather than chains 26 and sprockets 22, 24.

As shown, the membrane 28 is positioned relative to the supply of water 14 such that a portion of the membrane 28 is submerged in the supply of water 14. However, the relative depth of submersion of the membrane 28 is not so limited. In embodiments using raceways or lakes as the supply of liquid 14, the membrane 28 may be increased in size according to the size of the raceway or lake, and/or several membranes 28 may be provided. Moreover, the depth of submersion of the membrane(s) 28 in those embodiments may be increased substantially, depending on the size of the membrane 28 as well as the depth of the raceway or lake, for example. In the embodiment shown, the supply of liquid 14 is not flowing in the membrane. However, in other embodiments, the liquid 14 in the reservoir 12 may be flowing, i.e., relative to the membrane 28 and/or the reservoir 12. In that regard, the reservoir 12 may include features that cause a flow of the liquid 14 relative to the membrane 28 and/or the reservoir 12. In embodiments using a raceway or lake, for example, the liquid may be essentially stationary, or alternatively may be flowing.

In the embodiment shown, the membrane 28 is a continuous loop having opposing outer edges 30. The membrane 28 may be constructed as a single continuous annular structure, or may include two or more portions coupled together to form the continuous loop. The membrane 28, as shown best in FIGS. 2B and 2C, is a woven structure having fibers 29 of one material. However, in other embodiments, the membrane 28 may be a woven structure of more than one material, or may be a non-woven structure (i.e., felt) of one or more materials. Potential materials include fabrics, polymers such as polypropylene and nylon, and others that may be configured to form a generally porous, hydrophilic membrane 28 that allows the formation of a film 32 (FIG. 2C) of the liquid 14 thereon when wetted. While the fibers 29 may be made from a material that is itself hydrophobic, the configuration of the membrane 28 may allow for the formation of the film 32 such that the membrane 28 itself is generally hydrophilic. In that regard, the membrane 28 may be porous, such that the liquid may be captured by the pores. Once the pores capture a certain amount of liquid, the cohesiveness of the water 14 or other liquid, may allow for the drawing up or capture of an additional water 14 and thus the formation of the film 32. In the embodiment shown, the membrane 28 includes a width w of approximately 25 inches and height h of approximately 94 inches. The size of the membrane 28 in other embodiments may be smaller or substantially larger, and depend on different characteristics of the system 10. Due to the possible different sizes of membranes 28 that may be used, the system 10 may be adjustable. For example, the upper sprockets 22 may be movable in the upward or downward directions, or both sets of sprockets 22, 24 may be movable in the left or right directions (as viewed from FIG. 1) in order to accommodate for size changes of the membrane 28. Moreover, multiple sizes of reservoirs 12 may be provided in order to accommodate for different sizes of membranes 28. Adjustment of the system 10, such as the distance between the upper and lower sprockets 22, 24, may provide an increase or decrease in tension on the membrane 28. While placing additional tension on the membrane 28 may be advantageous, it is not required in order for the membrane 28 to draw up water 14 from the reservoir 12 and form a film 32 on the membrane 28. The membrane 28 is sized in order to maintain a film 32 (FIG. 2C) thereon during a full rotation, until being submerged (described hereinbelow), so that the gas that has been transferred to the aqueous phase within the film 32 may be transferred to the supply of water 14 in the reservoir 12.

As shown, the membrane 28 is engaged with the drive system 16 such that operation of the drive system 16 causes the rotation of the membrane 28 relative to the supply of liquid 14. More particularly, the membrane 28 is engaged or operably coupled with each chain 26 via a connection element, shown as a belt 33. As shown, the membrane 26 is operably coupled to each chain 26 substantially at or near each of the opposing edges 30. The engagement between the chains 26 and the membrane 28 at the outer edges 30 of the membrane 28 is advantageous in that it does not hamper a film 32 of liquid 14 from forming on the membrane 28, as described below. In an alternative embodiment, the connection element may include a plurality of discrete members (not shown) configured to engage the membrane 28. The discrete members may be disposed along the length of each chain 26 and spaced apart from one another. In another alternative embodiment, the membrane 28 may be attached to the components of the drive system 16 via a connection element in the form of adhesive-backed, waterproof (i.e., marine grade) hook and loop fastening system such as Velcro brand (not shown). Use of a Velcro type fastening system may ensure a large point of contact between the membrane 28 and the drive system 16, and may prevent tearing of the membrane 28 and reduce installation time. The use of Velcro may be most advantageous in the embodiment using a belt system rather than chains 26, but may also be used in the embodiment including chains 26.

As shown best in FIGS. 2B-2C, as the membrane 28 rotates relative to the supply of water 14, the portion of the membrane 28 that is submerged begins to exit from the water 14. Due to the cohesion properties of water 14, and due to the hydrophilicity of the membrane 28, a film 32 of the water 14 is formed on the membrane 28. Preferably, the film 32 has a thickness substantially equal to a thickness of at least some of the membrane fibers 29. Because the gas to liquid mass transfer rate increases as the thickness of the film 32 is decreased, it is preferable to provide a thin membrane 28. Eventually, the membrane 28 will have rotated a full rotation such that a portion that was originally submerged will have exited the supply of water 14, moved in an upward direction, around the upper set of sprockets 22, back in a downward direction, and again into the water 14. Thus, the soluble gas that has dissolved into the film 32 will be directed into the supply of liquid 14 once the wetted portion of the membrane 28 is submerged into the supply of liquid 14. Because a minimal amount of water 14 will be dripping into the supply of water 14, splashing is substantially reduced or eliminated. As shown, the membrane 28 traverses a loop-shaped path. In other embodiments, the path traversed by the membrane 28 during movement thereof may be of a different shape or configuration.

The membrane 28 is moved at a speed relative to the supply of water 14 that allows the film 32 to form on the membrane 28, that allows the film 32 to be maintained on the membrane 28 as the membrane 28 rotates, and that provides a sufficient time for the film 32 to interact with and allow dissolution of the soluble gas, such as carbon dioxide or ammonia. Thus, the speed of the membrane 28 is preferably chosen such that the film 32 forms on the membrane 28 as it exits from the water 14, is maintained as the membrane 28 moves upwardly, around the upper set of sprockets 22, and finally in the downward direction and back into the supply of water 14. The gas may be transformed to the aqueous phase as it dissolves in the film 32 of water 14, and at least a portion of the aqueous phase dissolved gas may be transferred to the supply of water 14 as the wetted portion including dissolved gas is again submerged into the supply of water 14. Because at least a portion the dissolved gas is transferred to the supply of water 14 as the membrane is submerged after a rotation, it is advantageous to maximize the amount of dissolved gas in the film 32. In order to do so, the characteristics of the membrane 28 and/or the system 10 may be altered. The thickness of the film 32 directly influences the mass transfer rate and thus the amount of aqueous phase gas that is dissolved in the film 32. As the thickness of the film 32 decreases, the mass transfer rate increases. Thus, a thinner film 32 will allow for relatively quicker dissolution of a soluble gas in the film. However, a thinner film 32 may also become saturated with the dissolved gas more quickly. Thus, the membrane 28 is configured to allow the formation of a film 32 that is thin enough to allow a faster rate of mass transfer, but thick enough such that the film 32 does not become saturated with the dissolved gas quickly. It is also advantageous to minimize the time between when the film 32 becomes saturated and when the membrane 28 is again submerged into the water 14 after a rotation. In one embodiment, the membrane 28 is configured such that the film 32 formed on the membrane 28 will become saturated with the soluble gas prior to being submerged into the supply of water.

The speed of the membrane 28 may also be altered in order to minimize the time between the film 32 becoming saturated with the dissolved gas and the membrane 28 being submerged in the water 14 after a rotation. For example, with a relatively thinner film 32 that would become saturated more quickly, the speed of the membrane 28 may be increased so that the saturated film 32 may be submerged more quickly. On the other hand, a relatively thicker film 32 would become saturated more slowly, and thus the speed of the membrane 28 may be adjusted accordingly. Thus, in one embodiment, the membrane 32 is configured to allow the formation of a film 32 upon exiting from the supply of liquid 14, and does not become saturated with the dissolved soluble gas until a point just prior to being re-submerged into the supply of liquid 14. In one embodiment, the membrane 28 is moved relative to the supply of liquid 14 at a rate that allows the film 32 to become saturated with dissolved soluble gas before the wetted portion is submerged in the supply of water 14.

The amount of gas dissolved in the film 32 of water 14 may also be influenced increasing the exposure of the membrane 28 to air or gas. For example, a greater amount and/or higher concentration of the soluble gas may be exposed to the membrane 28. In the embodiment shown, the system 10 includes an optional housing element 34 (shown in phantom) generally encasing at least the membrane 28 and certain portions of the drive system 16. The housing element 34 may or may not be hermetically sealed. As shown, the housing element 34 is in fluid communication with a gas supply 36, which may include a concentrated supply of soluble gas, such as carbon dioxide or ammonia. The housing element 34 may also be in fluid communication with a vent 38 to allow gas to be vented from the housing element 34. In another embodiment, at least one fan (not shown) may be used in order to direct a forced flow of air or gas towards the membrane 28.

As an example, the system 10 of the present invention may be installed in a duct system with flue gas flowing across the surface of the membrane to absorb carbon dioxide. This system will increase mass transfer due to the increased bulk transfer and ease of connecting to an existing flue gas point, such as an exhaust duct, with increased diffusion due to the elevated carbon dioxide environment. Such a system also has the ability to enable one to shut down the section of the mass transfer system for maintenance or otherwise.

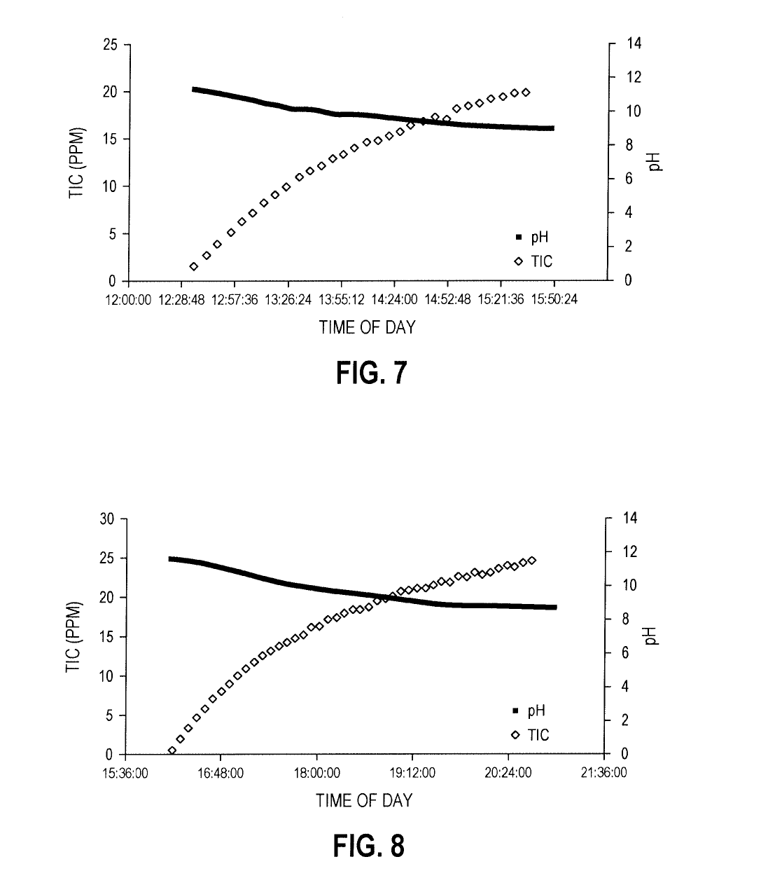

Several tests have been performed in order to determine the efficacy of the technology. FIGS. 4 and 5 show the results of one test, in which the input power required to drive the motor 18 was quantitatively characterized. The membrane 28 speed was adjusted in increments of 10% from 0-100% motor speed using a motor controller (not shown). Input power was measured using a power meter. The maximum measured power was 36 W at 100% maximum motor speed. Using the inputs shown in FIGS. 4 and 5, the linear speed of the membrane 28 exiting the supply of water 14 and entering the supply of water 14 ranged from approximately 0.60 meters per second (m/s) to approximately 5 m/s. The efficacy of various membranes 28 was also tested. Specifically, tests were conducted to discover whether a membrane 28 maintains a film 32 from the time it exits the supply of liquid 14 until being again submerged in the supply of liquid 14. A film 32 is maintained in this manner in at least the range of speeds (approximately 0.5 m/s to approximately 5.0 m/s) in various membranes 28, including the embodiments of membranes 28 described hereinabove. Preferably, the membrane 28 includes a porosity of between approximately four percent (4%) to more than fifty percent (50%), and up to approximately 90%. As described herein, porosity is equal to the area of voids divided by the total area of the membrane 28. It will be understood that, in some instances, the film 32 may cover only a portion of the membrane 28. For example, the contact between the chain 26 or belt 33 at or near each of the outer edges 30 may disrupt a film 32 from forming at or near the outer edges 30.

Further, the system 10 may be designed for promotion of algae growth. If so, the membrane, along with its drive system 16, as well as the reservoir for water supply 14, are designed to maximize exposure of the liquid to light. In other words, the reservoir 12 along with the drive mechanism 16 and membrane 28 may be offset relative to a pond or raceway to avoid shading the pond or raceway, with the reservoir 12 still being in fluid communication with a supply of liquid 14.

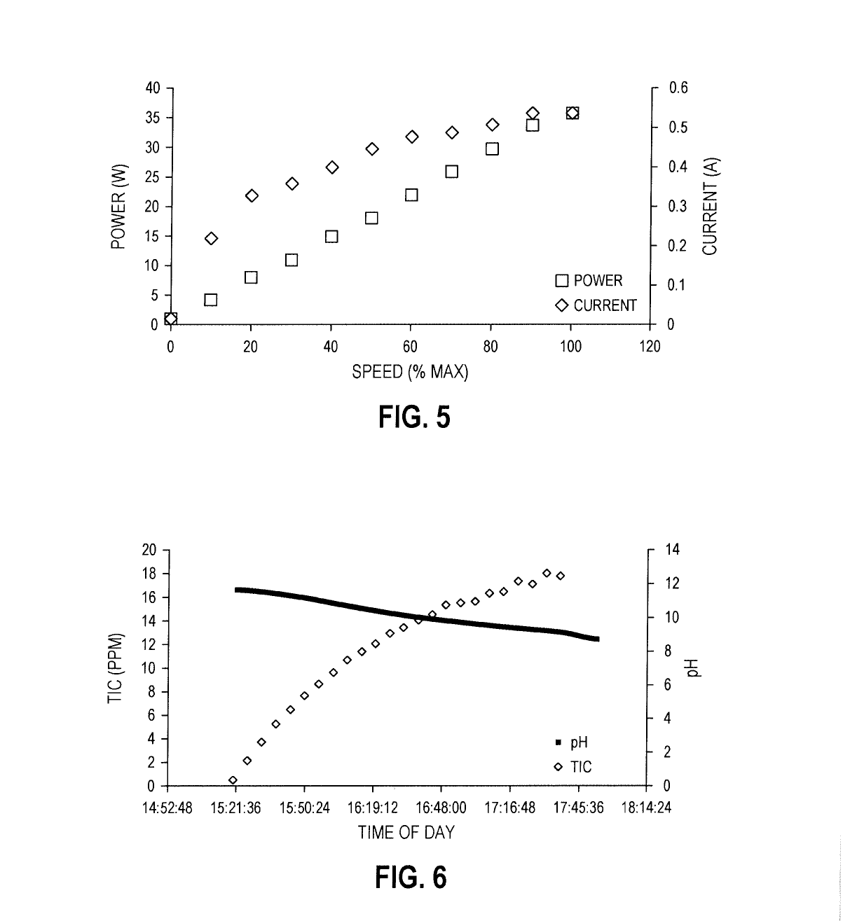

It may or may not be advantageous in for microalgae to form and stick to the membrane 28. A test was run in order to investigate whether microalgae would adhere to the membrane 28. A mixture of tap water and a solution containing Scenedesmus dimorphus, totaling between approximately 7 and approximately 9 gallons, were added to the reservoir 12. Four turbidity measurements were taken using a Hach turbidimeter. The measurements read 92, 90, 91, and 89 NTU for an average reading of 90.5 NTU. The system 10 was operated such that the motor 18 was run at 90% speed for approximately 5 hours. During operation, larger chunks of algae attached to the membrane 28 almost immediately upon commencing rotation, but were washed off within about 5 to about 10 minutes. During the remainder of the test, no algae attachment on the membrane 28 was observed.

Where algae attachment is desired, however, the membrane 28 may be altered or modified with features that encourage microalgae attachment. For example, in an alternative embodiment, referring to FIG. 3, a hybrid membrane 40 may be provided and is comprised of three layers. As shown, the three layers include a substrate layer 42 with a mesh layer 44 on each side thereof. The substrate layer 42 may be configured to support algae growth and be made of cotton, for example, but is not so limited in material selection. The mesh layers 44 may be substantially similar to the different embodiments of the membrane shown in FIGS. 1 and 2 as described herein, and provided for the purpose of drawing up water 14 and algae until the algae is able to attach to the substrate layer 42. Once an amount of algae has attached to the membrane 28 or membrane 40, it may be advantageous to harvest the attached algae. Therefore, in alternative embodiment, a scraper (not shown) may be provided to scrape algae off of membrane 28 or membrane 40 for processing into a biofuel or for another use, for example. The scraper may be connected to or coupled with the system 10, and may be automated or controlled via a control mechanism by user. Once scraped, the algae may be transferred to a storage or transfer device for further storage, processing, or use.

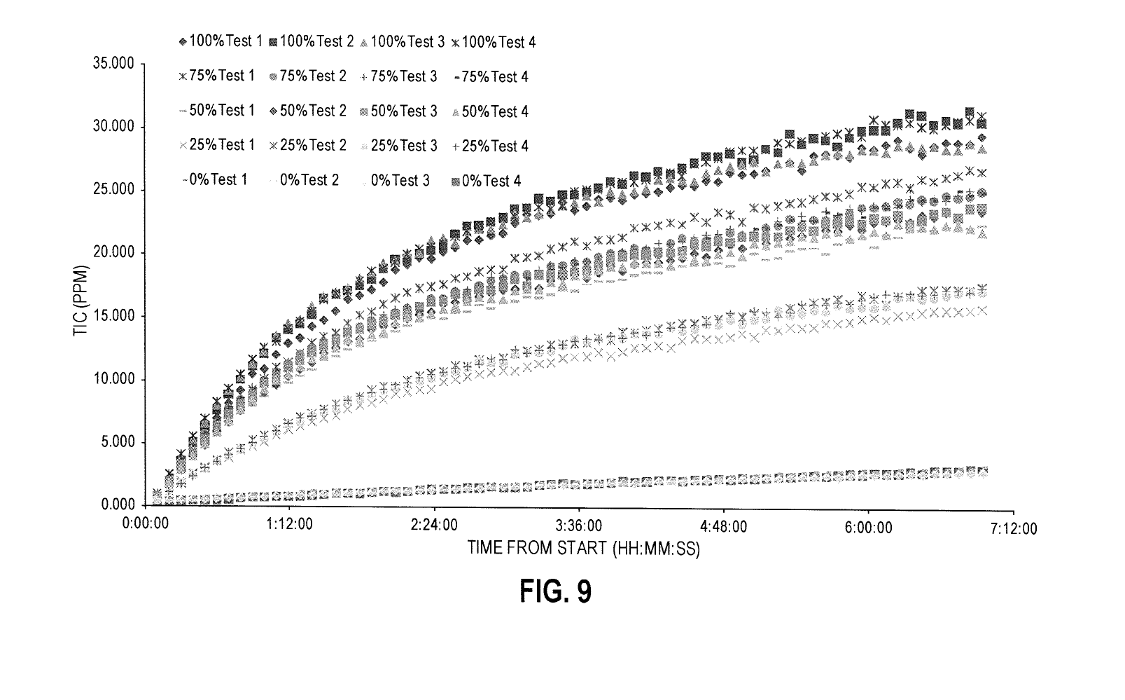

Multiple tests were performed to measure the total inorganic carbon (TIC) and monitor the pH, temperature, salinity, conductivity, and dissolved oxygen over time as the system 10 operated. An OI Analytical TIC machine was used to measure the TIC amount present in the supply of liquid 14, while a YSI 5200A system was used to monitor the other characteristics. As shown in FIG. 6, in one of the tests, the pH in the supply of liquid 14 decreased over a period of approximately 2.5 hours to a value of approximately 8.17. As shown, the TIC concentration, after approximately 2.5 hours, approaches about 18 parts per million (ppm). In another test, referring to FIG. 7, over a period of approximately 3.5 hours, the pH decreased and to at a level of approximately 9. As shown, the TIC levels off after 3.5 hours at about 20 ppm. In another test, referring to FIG. 8, over a period of approximately 5 hours, the pH decreased to a level of approximately 8.5. As shown, the TIC level leveled off at 25 ppm. It has been observed that TIC saturates at approximately 45 ppm at the tested gas phase C_{O2} concentration. Notably, a sodium hydroxide (NaOH) buffer may be added in order to prevent an abrupt change in pH during use of the system 10. FIG. 9 shows results of several tests at 100%, 75%, 50%, 25% and 0% motor speed, which directly relates to the speed of the membrane 28. More particularly, FIG. 9 shows a plot of time vs. TIC concentration at these various speeds during the course of four tests. As described above, the mass transfer rate of soluble gas into the film 32 may be altered by adjusting the membrane speed, which also affects the amount of TIC delivered to the supply of water 14.

Thus, the system 10 as described herein provides a manner in which the mass transfer rate of a soluble gas, such as carbon dioxide or ammonia, is enhanced. The system 10 is applicable to a wide variety of applications, such for the sequestration of carbon dioxide, ammonia, and other soluble gases that are emitted in variety of processes. Other applications include the production of microalgae as a feedstock for the mitigation of carbon dioxide emission, and the production of biofuels. The system 10 provides these benefits and advantages in a more efficient and potentially lower cost manner than existing systems.

While the present invention has been illustrated by a description of various preferred embodiments and while these embodiments have been described in some detail, it is not the intention of the Applicants to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with the preferred methods of practicing the present invention as currently known. However, the invention itself should only be defined by the appended claims.

What is claimed is:

1. A method for enhancing the mass transfer rate of a soluble gas from a gaseous phase to an aqueous phase, comprising:
positioning a membrane formed from fibers relative to a supply of liquid such that a portion of the membrane is submerged in the supply of liquid and is thereby wetted;
moving the wetted portion of the membrane relative to the supply of liquid such that the wetted portion of the membrane exits from the supply of liquid to expose the liquid in the wetted portion of the membrane to a soluble gas; and
submerging the wetted portion in the supply of liquid.

2. The method of claim 1, wherein positioning the membrane further comprises:
mounting the membrane on a drive system configured to rotate the membrane relative to the supply of liquid.

3. The method of claim 1, wherein moving the wetted portion of the membrane relative to the supply of liquid further comprises:
rotating the membrane relative to the supply of liquid.

4. The method of claim 1, wherein moving the wetted portion further comprises:
moving the wetted portion relative to the supply of liquid at a rate sufficient to maintain a film of liquid on the membrane.

5. The method of claim 4, wherein moving the wetted portion of the membrane relative to the supply of liquid further comprises:
moving the wetted portion of the membrane relative to the supply of liquid at a rate that allows the film to become saturated with dissolved soluble gas before the wetted portion is submerged in the supply of liquid.

6. The method of claim 5, further comprising:
moving the wetted portion of the membrane relative to the supply of liquid at a rate that allows the film to become saturated with dissolved soluble gas before the wetted portion is submerged in the supply of liquid.

7. The method of claim 1, wherein the membrane comprises a continuous loop of material having first and second opposing edges, and the method further comprises:
engaging the membrane with a drive system at or near each of the first and second opposing edges.

8. The method of claim 1, wherein the supply of liquid comprises water, and the gas comprises carbon dioxide, ammonia, or other soluble gases.

9. The method of claim 1, wherein positioning the membrane further comprises:
positioning the membrane such that at least a portion of the membrane remains submerged when the membrane is moving relative to the supply of liquid.

10. The method of claim 1, further comprising:
repeating the moving and submerging steps until substantially the entire membrane is wetted.

11. The method of claim 1, further comprising:
exposing the wetted membrane to a higher concentration of the soluble gas than a concentration of the soluble gas in ambient air.

12. The method of claim 11, wherein exposing the wetted membrane to a higher concentration of the soluble gas further comprises:
encasing at least the membrane within a housing element; and
directing an amount of the soluble gas at the higher concentration into the housing element.

13. The method of claim 1, wherein positioning the membrane relative to a supply of liquid further comprises:
positioning the membrane relative to a raceway, lake, pond, or other body of water.

14. A system for enhancing the mass transfer rate of a soluble gas from a gaseous phase to an aqueous phase, comprising:
a membrane comprised of a plurality of fibers and positioned relative to a supply of liquid such that at least a portion of the membrane may be submerged in the supply of liquid and thereby wetted; and
a drive system configured to engage the membrane and move the wetted portion of the membrane into and out of the supply of liquid.

15. The system of claim 14, wherein the membrane, after being wetted and moved out of the supply of liquid, is configured to maintain a film of liquid of a thickness substantially equal to a thickness of at least some of the fibers until the wetted portion is submerged in the supply of liquid.

16. The system of claim 14, further comprising:
a housing element configured to encase at least part of the system from an ambient environment, the housing element including an inlet for fluid communication with a supply of soluble gas.

17. The system of claim 16, further comprising:
a supply of the soluble gas having a concentration higher than a concentration of the soluble gas in an ambient environment.

18. The system of claim 14, wherein the membrane includes a porosity of between approximately 4% and approximately 90%.

19. The system of claim 14, further comprising:
a connection element operably coupling the membrane and the drive system.

20. A method for transferring a soluble gas from a gaseous phase to an aqueous phase, comprising:
positioning a membrane formed from fibers relative to a supply of liquid such that a portion of the membrane is submerged in the supply of liquid;
moving the membrane relative to the supply of liquid such that the submerged portion of the membrane exits from the supply of liquid, thereby forming a film of the liquid on the membrane, wherein soluble gas dissolves into the film; and
submerging the portion of the membrane including the film in the supply of liquid after the film becomes saturated with the dissolved soluble gas.
